(19) United States
(12) Patent Application Publication
(10) Pub. No.: US 2004/0252188 A1
(43) Pub. Date: Dec. 16, 2004

(54) Methods and apparatus for imaging

(76) Inventors: Gueorgui H. Stantchev, Phoenix, AZ (US); Jason C. Elder, Chandler, AZ (US); Egidio Cianciosi, Scottsdale, AZ (US)

Correspondence Address: NOBLITT & GILMORE, LLC., 4800 NORTH SCOTTSDALE ROAD, SUITE 6000, SCOTTSDALE, AZ, 85251, US

(21) Appl. No.: 10/730,746

(22) Filed: Dec. 7, 2003

Related U.S. Application Data
(60) Provisional application No. 60/456,366, filed on Mar. 21, 2003.

(51) Int. Cl. H04N 7/18

(52) U.S. Cl. 348/77

(57) ABSTRACT

A dental imaging system according to various aspects of the present invention comprises a sensor and a base unit. The sensor is configured to generate image data relating to a target and transfers the information to the base unit. The base unit is configured to receive the image data for storage and/or distribution, for example to another device or system.

### CROSS-REFERENCES TO RELATED APPLICATIONS

This application:

claims the benefit of U.S. Provisional Application No. 60/456,366, filed Mar. 21, 2003; and

is a continuation-in-part of U.S. patent application No.______, filed Feb. 14, 2003, entitled DENTAL IMAGING SYSTEM AND APPARATUS USING IEEE 1394 PROTOCOL.

### FIELD OF THE INVENTION

The invention relates to methods and apparatus for making, storing, transporting, and viewing images.

### BACKGROUND OF THE INVENTION

Teeth and gums are susceptible to a wide array of diseases and disorders that manifest themselves in various ways, including changes in bone and tooth density and geometry. Early detection and diagnosis often allow treatment. Imaging systems, such as radiographical and optical imaging systems, may detect such changes in tooth and bone density and geometry. Such systems also assist in tracking the progress of a patient over time by making a visual record.

Various imaging systems have been developed for assisting the specialist in making dental images. Basic imaging systems are conventional cameras using exposures of film that may be developed into photographs for review and storage. More modern systems employ digital technology to generate digital images that may be printed to make conventional prints and/or stored electronically. In either case, the images are typically first recorded in an onboard medium, such as film or a memory. The film may then be developed, or the digital image data transferred to a computer for review and storage.

Such conventional imaging systems are not, however, adapted especially well for dental applications. For example, conventional cameras cannot penetrate into the oral cavity to get an image of selected oral tissue from many angles. Even if the camera may be positioned properly, the lighting mechanism may not fit into the oral cavity. Consequently, the lighting may be inadequate or suboptimal, resulting in a poor image.

In addition, such systems may be awkward or time consuming to operate. For example, digital systems ordinarily require a computer system to download the images from the camera and interface with other electronic systems, such that after a series of images are taken, the image data is transferred to the computer system for processing and transfer to other devices. In addition, digital images are often not available for viewing and manipulation until well after the image is taken, such that if the images are unacceptable, they must be taken again to achieve the required results.

### SUMMARY OF THE INVENTION

A dental imaging system according to various aspects of the present invention comprises a sensor and a base unit. The sensor is configured to generate image data relating to a target and transfers the information to the base unit. The base unit is configured to receive the image data for storage and/or distribution, for example to another device or system.

In one embodiment, the base unit is configured as a network device such that the images may be routed to any suitable device connected to the network, such as a monitor, a remote wireless display, a computer, a storage system, or the like. The base unit may also be configured to adjust the image data for use by other systems. In various embodiments, the sensor may be configured to include a light source for illuminating a target within the oral cavity, for example using a substantially white light-emitting diode (LED). The light source may also include a diffuser to diffuse the light incident upon the target.

### BRIEF DESCRIPTION OF THE DRAWING FIGURES

A more complete understanding of the present invention may be derived by referring to the detailed description when considered in connection with the following illustrative figures. In the following figures, like reference numbers refer to similar elements and steps.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

FIG. 1 is a block diagram of an imaging system according to various aspects of the present invention;

FIGS. 2A-B are diagrams of imaging systems using physical and wireless connections;

FIG. 3 is a block diagram of an exemplary sensor;

FIG. 4 is an exploded view of the sensor;

FIGS. 5A-B are top and side views, respectively, of the sensor;

FIGS. 6A-B are perspective views of a portion of the sensor including a light source;

FIG. 7 is a cross-sectional diagram of a light block;

FIG. 8 is a perspective view of a camera unit interface;

FIG. 9 is a perspective view of the sensor and the camera unit interface;

FIG. 10 is a block diagram of the camera unit interface; and

FIG. 11 is a block diagram of a base unit.

### DETAILED DESCRIPTION OF EXEMPLARY EMBODIMENTS

The present invention is described partly in terms of functional components and various processing steps. Such functional components and steps may be realized by any number of components and steps configured to perform the specified functions and achieve the various results. For example, the present invention may employ various elements, materials, sensors, processors, communications media, video protocols, and the like, which may carry out a variety of functions. In addition, the present invention may be practiced in conjunction with any number of applications, environments, imaging techniques, and communications media, and the systems described are merely exemplary applications for the invention. Further, the present invention may employ any number of conventional techniques for manufacturing, assembling, communications, and the like.

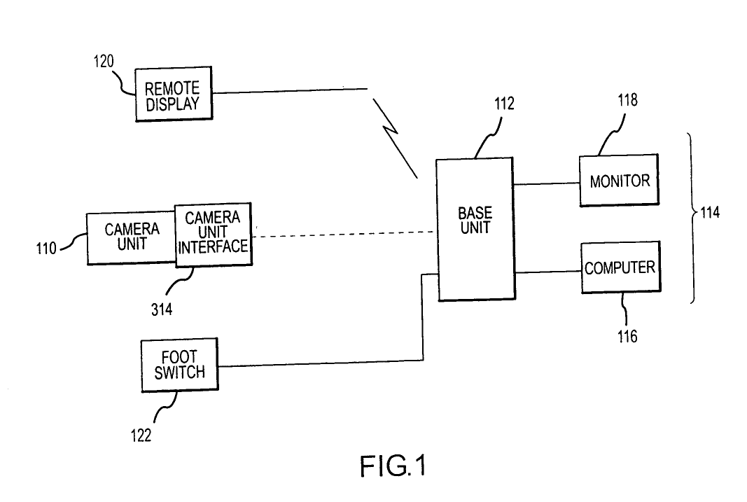

Referring now to FIG. 1, an imaging system 100 according to various aspects of the present invention comprises a sensor 110, a base unit 112, and one or more connected devices 114. Generally, the sensor 110 generates image data relating to a target, and the base unit 112 receives the image data from the sensor 110 and processes the data for use and/or transfer. The connected devices 114 may comprise devices for communicating with the base unit 112 and/or the sensor 110, such as displays and/or storage systems.

More particularly, the sensor 110 generates data for processing by the base unit 112 and/or transfer to the connected devices 114. The sensor 110 may comprise any appropriate sensor for generating information relating to a target, such as a light sensor, magnetic sensor, acoustic sensor, a complementary metal oxide semiconductor (CMOS) sensor, or other sensor. In the present embodiment, the sensor 110 includes an optical charge coupled device (CCD) for receiving light reflected from, transmitted by, or generated by a target, such as one or more teeth or other oral tissue, and generating image data corresponding to an image of the target. The sensor 110 may also comprise multiple sensors that may be individually or collectively connected to the base unit 112. The sensor 110 may also include a light source for illuminating the target.

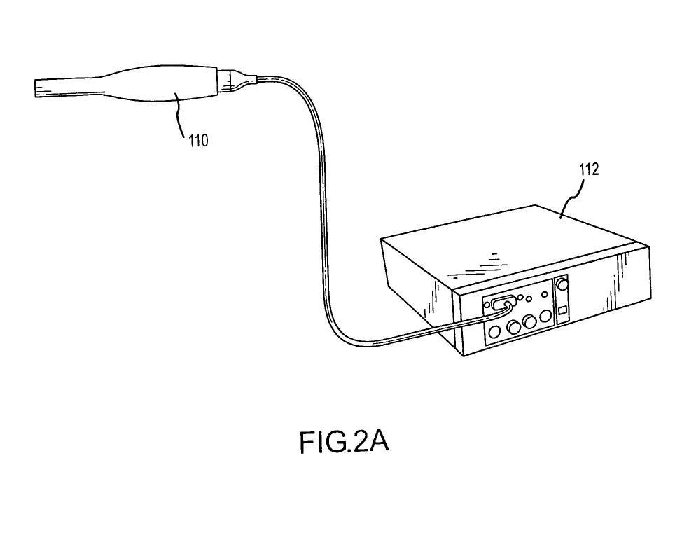

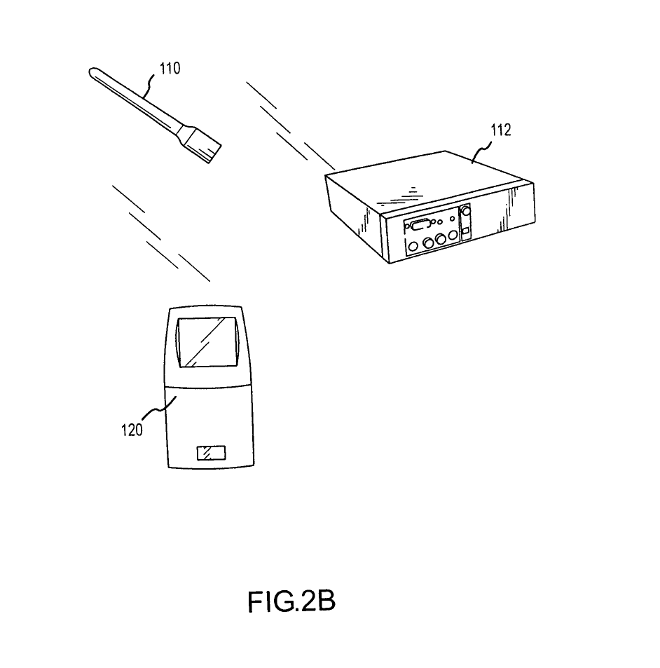

The sensor 110 may provide the data to the base unit 112 using any appropriate mechanism and/or medium, such as a wire or cord, a fiber optic cable, a wireless connection, or other suitable medium. For example, referring to FIG. 2A, the sensor 110 may be connected to the base unit 112 using a physical cord connection. In another embodiment, referring to FIG. 2B, the sensor 110 is connected to the base unit 112 via a wireless medium, such as a radio frequency medium. In addition, the sensor 110 and/or base unit 112 may transfer information to connected devices 114 via physical connections, wireless connections, or other appropriate media.

The base unit 112 provides an interface between the sensor 110 and the connected devices 114. For example, the base unit 112 is suitably configured to receive image data, such as video data or still image data, from the sensor 110 and store the data and/or format the data for transfer to the connected devices 114. The base unit 112 may also provide various support functions, such as power supply and regulation, light origination, video processing, and storage. The base unit 112 may also be configured as a network device, such as to communicate with the connected devices 114. For example, the base unit 112 suitably includes a networking card, such as an Ethernet or wireless networking card, to facilitate communications between the base unit 112 and the connected devices 114 via a network.

The connected devices 114 comprise devices that may receive information from, provide information to, control, or otherwise interact with the base unit 112. In the present embodiment, the connected devices 114 may include master devices configured to control the base unit 112, slave devices that are controlled by the base unit 112, and/or combinations of master and slave devices. The connected devices 114 are connected to the base unit 112 in any suitable manner, such as via a client-server or peer-to-peer network, for example a local area network (LAN), a wide area network, a metropolitan area network, the Internet, Bluetooth communication, FireWire connection, wireless connections, telephone connections, or any other suitable system for connecting the base unit 112 to the connected devices 114.

In the present embodiment, the connected devices 114 may include storage systems like hard drives or tape drives, printers, monitors, ports to other networks, and other computers. The connected devices 114 are connected to the base unit through a network medium, such as a network using one or more communications protocols and/or operating systems, such as Windows, Linux, UNIX, or other suitable systems or connections. For example, a monitor 116, such as a conventional cathode ray tube, may receive composite video signals via a physical connection. A laptop computer 118 may receive image data, such as full motion digital video, via a FireWire connection or other IEEE 1394 based system. Further, a remote display unit 120, such as a dedicated display or a personal digital assistant, may be connected to the sensor 110 and/or the base unit 112, for example via a LAN, wireless LAN, or RF wireless link.

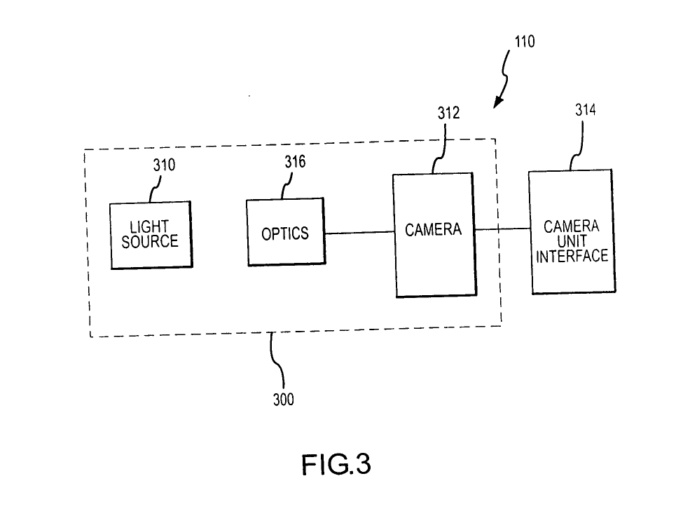

More particularly, referring now to FIG. 3, an exemplary sensor 110 according to various aspects of the present invention comprises a camera unit 300 including a light source 310 and a camera 312. The light source 310 illuminates the target and the camera 312 receives the light from the target and generates a corresponding signal. The corresponding signal may then be transmitted, for example to the base unit 112 and/or directly to the remote display unit 120, via a camera unit interface 314. In addition, the camera unit 300 may include optics 316 to direct light from the target to the camera 312.

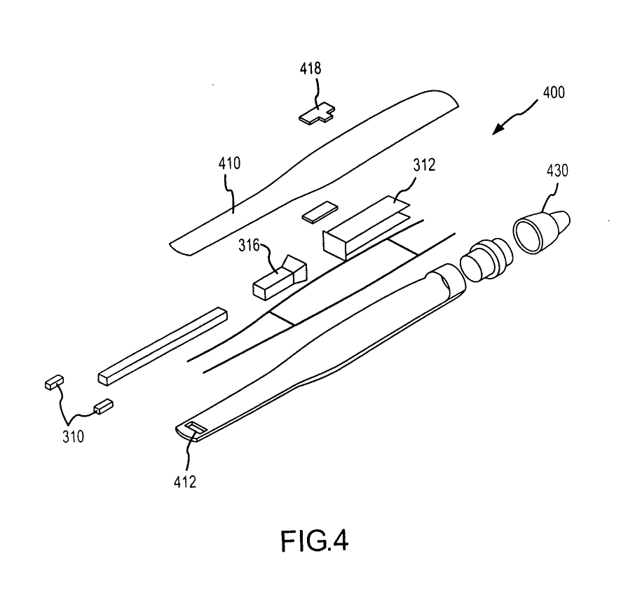

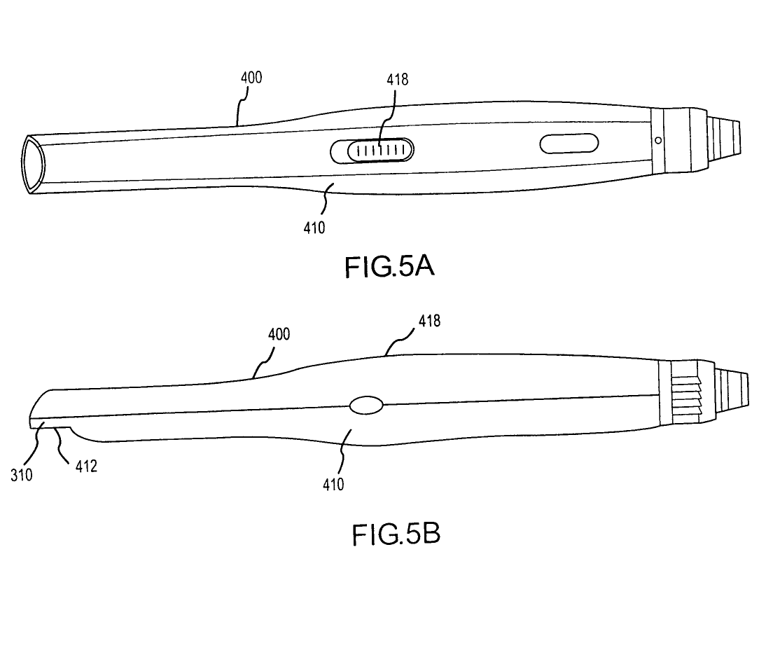

Referring to FIGS. 4 and 5A-B, an exemplary camera unit 400 according to various aspects of the present invention comprises a housing 410 having a light input 412; the light source 310; the optics 316; and the camera 312. The light source 310 may comprise any suitable system for illuminating the target. If the camera is sufficiently sensitive, however, the light source may be omitted. The light may be generated using any appropriate source, such as a light emitting diode (LED), luminescent lamp, or an incandescent bulb. For example, the light source may comprise an incandescent light source located in the base unit 112. Light from the incandescent bulb may be transmitted to the target, for example using a fiber optic bundle. In one embodiment, the fiber optic bundle transmits light to a location adjacent a light input of the camera unit 300.

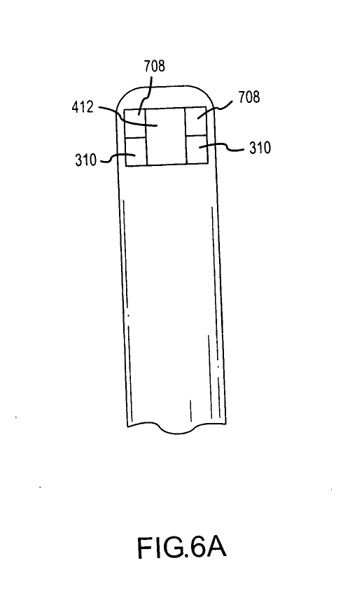

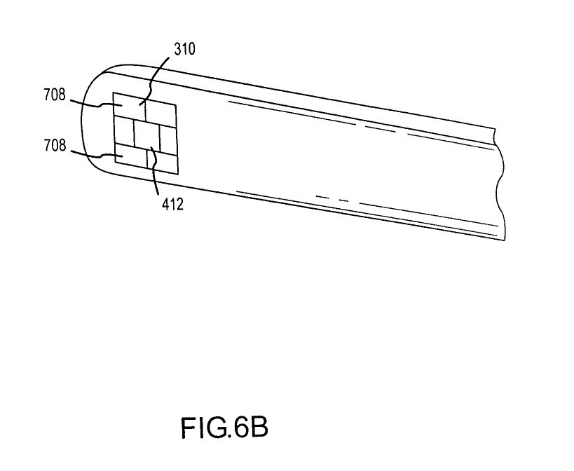

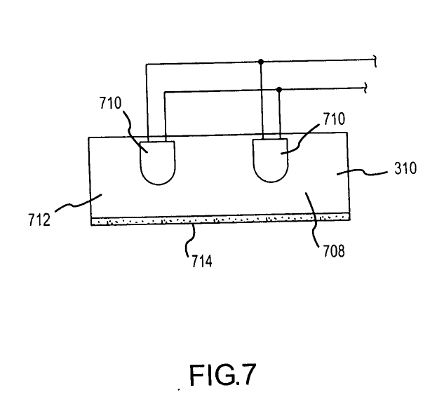

Referring to FIGS. 6A-B and 7, an alternative embodiment of a light source 310 comprises one or more light blocks 708. In the present embodiment, each light block 708 includes one or more light-generating elements, such as LEDs 710. The light-generating elements may be configured in any suitable manner to provide light to the target. In particular, the light blocks 708 may comprise two LEDs 710 disposed on either side of the light input 412. The light-generating elements may comprise, however, any appropriate light sources, such as colored LEDs, LEDs having different colors, or white LEDs. In the present embodiment, the light-generating elements comprise substantially white LEDs having high intensity and long life.

The light-generating elements are suitably disposed in or behind a solid substantially transmissive medium 712, such as glass or a substantially transparent plastic. The transmissive media 712 are mounted on either side of or around the light input 412 such that light from the light-generating elements is directed towards the target. The transmissive media 712 may protect the light-generating elements and maintain the position of the light-generating elements. In addition, the transmissive media 712 may provide optical filtering, for example to reduce certain frequencies of light from the light-generating elements.

The light source 310 may also include a diffuser 714 to diffuse the light from the LEDs 710. The diffuser 714 may comprise any suitable system for diffusing light, such as a diffusing plastic or glass attached to the front of the transmissive media 712. In the present embodiment, the diffuser 714 comprises a roughened front surface of the transmissive media 712. The transmissive media 712 may be roughened in any appropriate manner, such as using an abrasive. Alternatively, the transmissive media 712 may be otherwise treated or configured to diffuse the light from the LEDs 710, such as by adding a diffusing component to the interior of the transmissive media 712 or by forming the transmissive media 712 of a diffusing material.

Referring again to FIGS. 4 and 5A-B, the optics 316 direct light from the light input 412 to the camera 312. The optics 316 may comprise any suitable system for directing light to the camera 312. For example, in the present embodiment, the optics 316 comprise a prism 414 for reflecting light toward the camera 312 and a lens 416 for focusing the light. The optics 316 may also comprise a system for moving the lens with respect to the camera 312. For example, in the present embodiment, the lens is mounted on a sliding mechanism attached to a thumb slider 418, which the operator may use to adjust the focus of the camera unit 400.

The camera 312 receives the light from the target and generates a corresponding signal. The camera 312 may comprise any suitable system for capturing images, such as a CCD. In the present embodiment, the camera 312 is configured to provide full motion video and generate corresponding signals.

The camera unit 300 may also include other components in various configurations. For example, the camera unit 300 may also include a video processor to process a video signal for transmission to the remote display unit 120. Alternatively, a video processor may be included in the base unit 112. Further, the camera unit 300 may include an adapter connection for operation with one or more other components. For example, the camera unit 300 may include an interconnect element 430, such as a multi-pin connection, configured to mate with a remote camera unit interface 314. The interconnect element 430 is suitably configured to be separable so that the camera unit 300 may be connected to different camera unit interfaces 314, for example to switch to freshly charged batteries while the batteries in another camera unit interface 314 recharge. In addition, the interconnect element 430 may be configured to connect to a physical cord or wire connection such that the camera unit 300 may operate with a cord or in a cordless configuration.

The camera unit 300 may also include interface components. For example, the camera unit 300 may include a mechanism for capturing a still image in a video signal. In the present embodiment, the camera unit 400 includes a freeze frame activator, like a foot switch 122 and/or a freeze frame button 432. Depression of the freeze frame button 432 or activation of another freeze frame activator sends a signal, such as to the base unit 112, to save the current video image as a still frame. The saved image may then be viewed, for example on the remote display unit 120 or on a connected device 114.

The camera unit interface 314 facilitates communication between the elements of the camera unit 110 and the base unit 112 and, in some configurations, the remote display unit 120. The camera unit interface 314 may also perform other functions, such as providing power for cordless operation. Further, the camera unit interface 314 may be configured as a separate unit, or integrated fully or partially into other elements of the imaging system 100, such as the camera unit 110 and/or the base unit 112. Various elements, such as transmitters, power supplies, processors, and the like may be added, omitted, or integrated into other components according to the configuration.

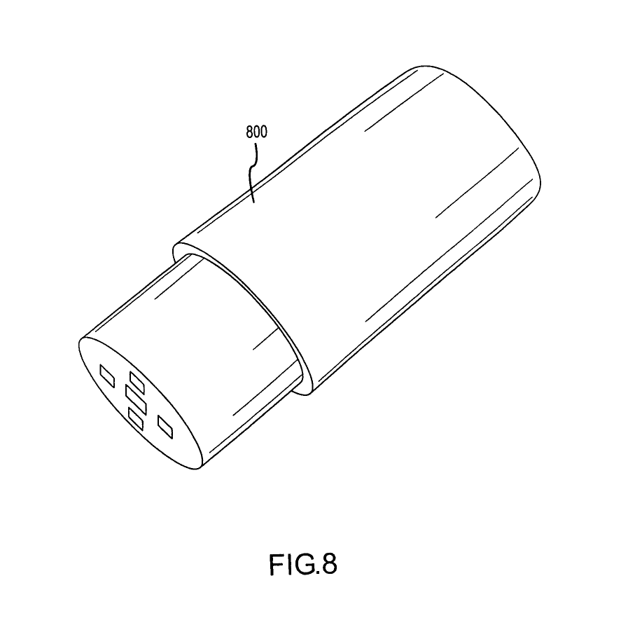

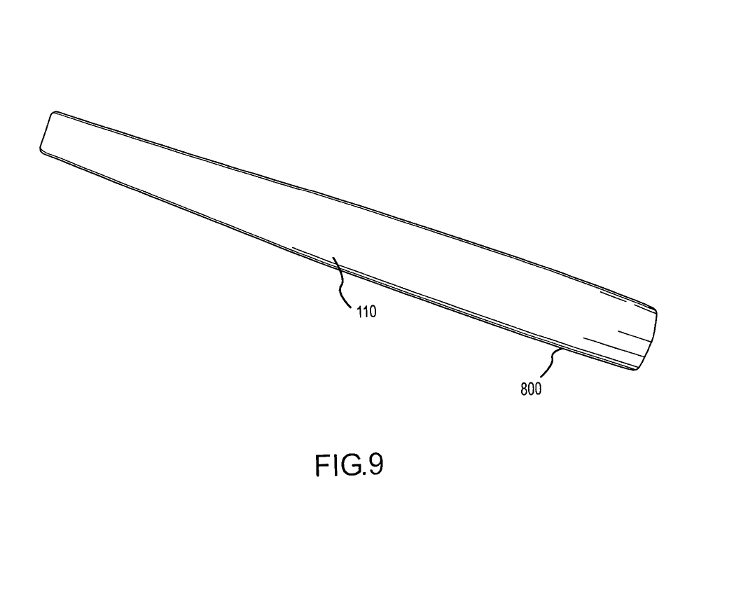

For example, in one embodiment, the camera unit interface 314 may comprise a separate unit to facilitate cordless operation. Referring to FIGS. 8 and 9, the camera unit interface 314 suitably comprises an integrated unit 800 that can attach to the camera unit 300, for example via the interconnect element 430. The integrated camera unit interface 800 suitably provides all of the functionality required for cordless operation.

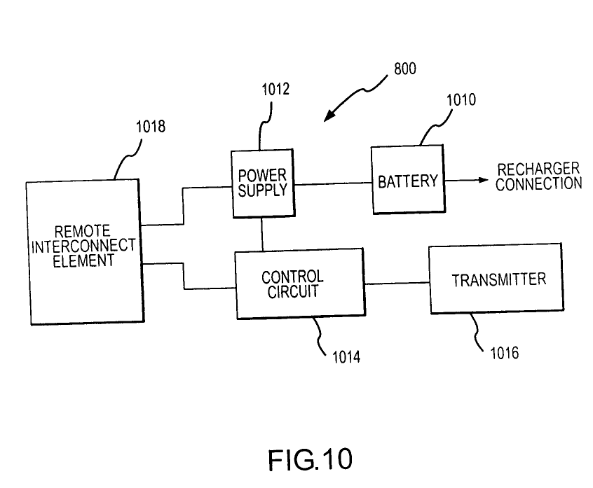

For example, referring to FIG. 10, the integrated camera unit interface 800 may comprise a battery 1010, a power supply 1012, a control circuit 1014, and a wireless transmitter 1016. The power supply 1012 supplies power at appropriate voltage and/or current levels to the camera unit interface 800 and the camera unit 300. The power supply 1012 also suitably provides power to the camera unit 300, for example via a remote unit interconnect element 1018. The power supply 1012 is driven by the battery 1010, which suitably comprises a rechargeable battery.

The control circuit 1014 suitably controls operation of the integrated camera unit interface 800, for example detecting connection to the camera unit 300 and controlling the transmission of signals from the camera unit 300. Signals are transmitted from the camera unit 300 to the base unit 112 via the wireless transmitter 1016. The control circuit 1014 may also control operation of the power supply 1012.

The base unit 112 receives data from the camera unit 110 and suitably processes the data. The base unit 112 may be configured in any suitable manner to receive and process the data. For example, the base unit 112 may be configured to receive data from multiple types of sensors and process the data to achieve any suitable objective, such as to transfer the data to a device, display the data on a local or remote display, perform image enhancement to improve the quality of the resulting image, store the image data, and/or compress the image data.

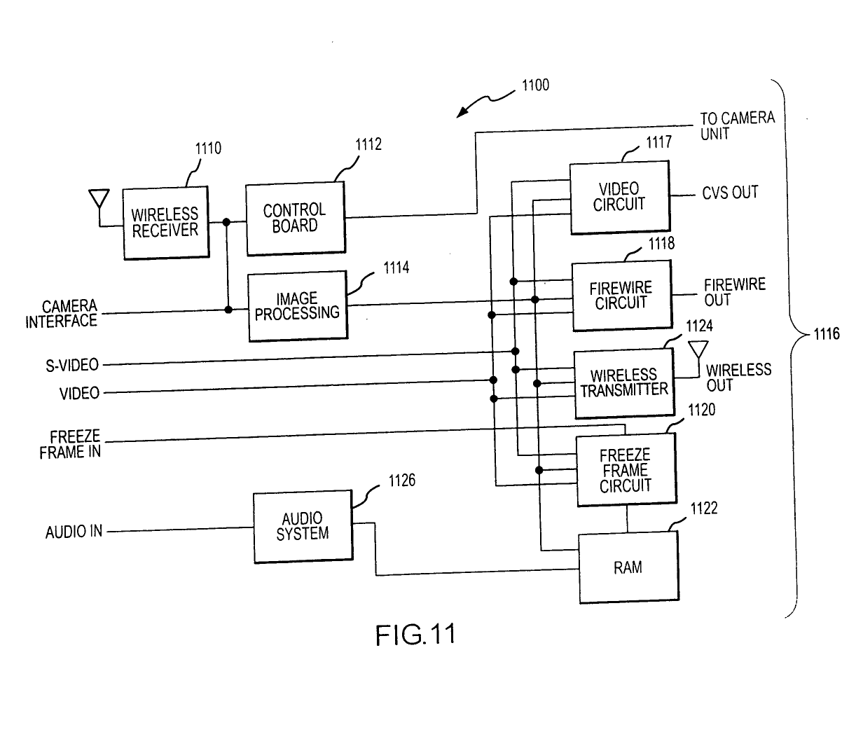

For example, referring now to FIG. 11, an exemplary base unit 1100 according to various aspects of the present invention comprises a receiver circuit 1110, a control system 1112, an image processing component 1114, and an external interface 1116. The receiver circuit 1110 receives signals from the camera unit 300 for transfer to the other components of the base unit 1100, and the control system 1112 controls the operation of the base unit 1100. The image processing component 1114 receives signals from the camera unit 300 and performs any appropriate processing, and the external interface 1116 facilitates the reformatting of the signal from the camera unit 300 and/or the image processing component 1114 for use by the connected devices 114.

In particular, the receiver circuit 1110 receives signals and transfers them to relevant components of the base unit 114. For example, the receiver circuit 1110 may comprise a wireless receiver for receiving wireless signals and converting them into electrical signals. The receiver circuit 1110 suitably provides control signals to the control system 1112, provides video signals to the elements of the external interface 1116, and the like. In addition, the receiver may convert signals to a useful form for use by the base unit 1100, such as conversion of the signal from an analog signal to a digital signal.

The control system 1112 controls the operation of the various elements of the base unit 1100, for example the activation of the base unit, memory accesses, and the like. The image processing component 1114 receives signals from the camera unit 300 and performs any appropriate processing, such as brightness adjustment, color adjustment, contrast adjustment, data smoothing, noise removal, or other suitable processing. The image processing component 1114 may be configured in any appropriate implementation, for example as a microprocessor or a digital signal processor.

The external interface 1116 facilitates the reformatting of the signal from the camera unit 300 and/or the image processing component 1114 for use by the connected devices 114. The external interface 1116 may be configured to process the image data for use by other systems, such as for transfer to the connected devices 114. The external interface 1116 suitably receives data after processing from the image processing component 1114 and conforms the data for output to a relevant device. The external interface 1116 suitably facilitates interaction with other devices such that the base unit 1100 may interact with various types of devices using different protocols, formats, and operating systems.

For example, data received by the external interface 1116 from the image processing component 1114 may comprise data in a digital video format. Any appropriate interface or set of interfaces may be used for the external interface 216 according to the desired and/or anticipated connected devices. For example, the external interface 1116 may include a digital video interface, such as a FireWire circuit 1118, another IEEE 1394-based or serial data transfer protocol and interconnection system, and/or a digital video system, to provide full motion video to a computer. The external interface 1116 also suitably includes a composite video signal circuit 1117 for providing video signals to a monitor. The external interface 1116 may comprise any suitable elements, however, for converting the signal into a signal for a particular connected device, such as a network card or other system.

The base unit 112 may also include various other elements to perform various functions. For example, the exemplary base unit 1100 may include a freeze frame board 1120 configured to store selected data, such as a particular frame of data, in response to a signal, for example from the freeze frame button 432 or the foot switch 122. The freeze frame board 1120 may store the selected data in any appropriate memory or other storage component, such as a random access memory (RAM) 1122. The data stored in the RAM 1122 may then be displayed or transferred to another device. In addition, the base unit 112 may include additional inputs, such as an S-video input and a video signal input. Signals received through such inputs may be routed in any appropriate manner, such as through the FireWire connection to the FireWire output or to another output.

Further, the base unit 112 may also include a wireless transmitter 1124 for communicating with various components, such as for providing video and still images to the remote display unit 120 and/or a wireless network. The base unit 112 may also include an audio component 1126 for receiving audio information, such as patient data, which may also be stored in the memory 1122 for later retrieval or playback.

In operation, the system may be activated, for example by automatically sensing removal of the camera unit 300 from a holder or depression of a power switch. Upon activation, the light source 310, the camera 312, and the base unit 112 may be powered up. The operator may then place the sensor near the target, such as a set of teeth in a patient's mouth. The light source 310 illuminates the target and the camera 312 records the images, for example as still photograph images or full motion video. The image data is transferred to the base unit 112 for processing.

The incoming signals may be processed in any suitable manner, such as to enhance or adjust the image. The image data is then transferred to the external interface 1116. The external interface 1116 reformats the image data for the particular connected device 114, and the data is transferred or made available to the selected connected devices 114, such as the remote display unit 120. In an embodiment with a monitor displaying images, such as a display connected to the base unit 112 or a handheld display, the operator may monitor the images as they are acquired. If the operator desires to save a particular frame in a video signal, the operator may request a freeze frame by depressing the freeze frame button or operating the foot switch. The resulting signal is transferred to the freeze frame circuit, which saves the image data for the frame in a memory for later use. If a particular image is unacceptable, the image may be reviewed and retaken.

The particular implementations shown and described are illustrative of the invention and its best mode and are not intended to otherwise limit the scope of the present invention in any way. Indeed, for the sake of brevity, conventional manufacturing, processing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

The present invention has been described above with reference to a preferred embodiment. However, changes and modifications may be made to the preferred embodiment without departing from the scope of the present invention. These and other changes or modifications are intended to be included within the scope of the present invention.

1. A dental imaging system for providing image data relating to a dental target, comprising:
a sensor configured to generate the image data relating to the target; and
a base unit connected to the sensor and configured to receive the image data from the sensor.

2. A dental imaging system according to claim 1, wherein the sensor comprises:
a light source; and
a diffuser proximate the light source, wherein the diffuser is configured to diffuse light from the light source.

3. A dental imaging system according to claim 2, wherein:
the light source is disposed behind a solid medium; and
the diffuser is at least one of integrated into the solid medium and attached to the solid medium.

4. A dental imaging system according to claim 3, wherein the diffuser includes a roughened surface of the solid medium.

5. A dental imaging system according to claim 3, wherein the diffuser includes the solid medium, and wherein the solid medium comprises a diffusing material.

6. A dental imaging system according to claim 1, further comprising at least one substantially white LED.

7. A dental imaging system according to claim 1, wherein the sensor is configured to generate a full motion video signal.

8. A dental imaging system according to claim 7, wherein the sensor includes a video processor.

9. A dental imaging system according to claim 7, wherein the base unit includes a video processor.

10. A dental imaging system according to claim 7, wherein at least one of the sensor and the base unit is configured to capture a single frame in the video signal.

11. A dental imaging system according to claim 10, wherein the sensor includes a freeze frame activator.

12. A dental imaging system according to claim 1, wherein at least one of the sensor and the base unit includes a network device.

13. A dental imaging system according to claim 1, further comprising a connected device connected to the base unit.

14. A dental imaging system according to claim 13, wherein the base unit is configured to adjust the data for use by the connected device.

15. A dental imaging system according to claim 13, wherein connected device is a wireless display.

16. A dental imaging system according to claim 1, wherein the base unit is connected to the sensor via a wireless connection.

17. A sensor, comprising:
a camera; and
a light source, comprising:
an LED configured to provide light along a light path to the camera; and
a diffuser interposed along the light path.

18. A sensor according to claim 17, wherein the sensor further comprises a housing defining a cavity, wherein the LED is disposed within the cavity, and wherein the diffuser covers the cavity in the housing.

19. A sensor according to claim 17, wherein the diffuser comprises a solid material, comprising:
a rear surface configured to abut the LED; and
a roughened front surface.

20. A sensor according to claim 17, wherein the sensor further includes a wireless interface connected to the camera and configured to transmit information from the camera.

21. A sensor according to claim 20, wherein the wireless interface is detachable from the camera.

22. A sensor according to claim 17, further comprising a base unit configured to receive signals from the camera.

23. A sensor according to claim 17, wherein the LED comprises a substantially white LED.

24. A sensor according to claim 17, further comprising a video processor connected to the camera.

25. A sensor according to claim 24, further comprising a freeze frame activator.

26. A sensor according to claim 17, further comprising a network device connected to the camera.

27. A dental imaging system base unit configured to receive data from a dental sensor, comprising:
a receiving component configured to receive signals from the dental sensor; and
an external interface connected to the receiving component and configured to reformat signals from the receiving component for transmission to a connected device.

28. A dental imaging system base unit according to claim 27, further comprising an image processing component connected to the receiving component for processing data the receiving component.

29. A dental imaging system base unit according to claim 28, wherein the image processing component includes a video processing component.

30. A dental imaging system base unit according to claim 27, wherein the receiving component comprises a wireless receiving component.

31. A dental imaging system base unit according to claim 27, wherein the external interface comprises a network device configured to communicate via a network.

32. A dental imaging system base unit according to claim 27, wherein the external interface comprises a digital video interface.

33. A dental imaging system base unit according to claim 27, wherein the external interface comprises a wireless transmitting system.

34. A dental imaging system base unit according to claim 27, further comprising a freeze frame system connected to the receiving component.

35. A dental imaging system base unit according to claim 27, further comprising a memory system connected to the receiving component.

36. A dental imaging system base unit according to claim 27, further comprising an audio system configured to receive and store audio information.

37. A dental imaging system for making an image of a target, comprising:
a sensor, comprising:
a light source configured to illuminate a target;
a camera configured to receive light from the light source via the target and generate a digital camera signal corresponding to the received light; and
a camera interface configured to receive the camera signal and transmit the camera signal;
a base unit connected to the sensor and configured to receive the transmitted camera signal and convert a first format of the camera signal to a second format; and
a connected device connected to the base unit and configured to receive the camera signal from the base unit, wherein the second format is a format that may be used by the connected device.

38. A dental imaging system according to claim 37, wherein the connected device comprises a wireless display.

39. A dental imaging system according to claim 37, wherein the light source includes at least one substantially white LED.

40. A dental imaging system according to claim 37, further comprising a diffuser proximate the light source, wherein the diffuser is configured to diffuse light from the light source.

41. A dental imaging system according to claim 40, wherein the diffuser comprises a solid material, comprising:
a rear surface configured to engage a surface of the light source; and
a roughened front surface.

42. A dental imaging system according to claim 40, wherein:
the light source is disposed behind a solid medium; and
the diffuser is at least one of integrated into the solid medium and attached to the solid medium.

43. A dental imaging system according to claim 42, wherein the diffuser includes a roughened surface of the solid medium.

44. A dental imaging system according to claim 42, wherein the diffuser includes the solid medium, and wherein the solid medium comprises a diffusing material.

45. A dental imaging system according to claim 42, wherein the sensor further comprises a housing defining a cavity, and wherein the light source is disposed within the cavity and the diffuser covers the cavity.

46. A dental imaging system according to claim 37, wherein the camera is configured to generate a full motion video signal.

47. A dental imaging system according to claim 46, wherein the sensor includes a video processor.

48. A dental imaging system according to claim 46, wherein the base unit includes a video processor.

49. A dental imaging system according to claim 46, wherein at least one of the sensor and the base unit is configured to capture a single frame in the video signal.

50. A dental imaging system according to claim 49, wherein the sensor includes a freeze frame activator.

51. A dental imaging system according to claim 37, wherein at least one of the sensor and the base unit includes a network device.

52. A dental imaging system according to claim 37, wherein the base unit is connected to the sensor via a wireless connection.

53. A dental imaging system according to claim 37, wherein the camera interface includes a wireless interface connected to the camera and configured to transmit information from the camera.

54. A dental imaging system according to claim 53, wherein the wireless interface is detachable from the camera.
